(19) United States
(12) Patent Application Publication
(10) Pub. No.: US 2018/0368084 A1
(43) Pub. Date: Dec. 20, 2018

(54) SELF-CONTAINED DMRS FOR PBCH IN SS BLOCK

(71) Applicant: LG ELECTRONICS INC., Seoul (KR)

(72) Inventors: Hyunsoo KO, Seoul (KR); Kijun KIM, Seoul (KR); Sukhyon YOON, Seoul (KR); Eunsun KIM, Seoul (KR)

(73) Assignee: LG ELECTRONICS INC., Seoul (KR)

(21) Appl. No.: 15/940,186

(22) Filed: Mar. 29, 2018

Related U.S. Application Data
(60) Provisional application No. 62/521,263, filed on Jun. 16, 2017.

(51) Int. Cl. H04W 56/00; H04L 5/00

(52) U.S. Cl. CPC H04W 56/001; H04L 5/0048; H04L 5/0007

(57) ABSTRACT

A method and apparatus for communicating demodulation reference signals (DMRSs) for a PBCH (Physical Broadcast Channel) signal are disclosed. The method comprises mapping a primary synchronization signal (PSS) and a secondary synchronization signal (SSS) to resource elements on a first group of OFDM (Orthogonal Frequency Divisional Multiplex) symbols within a synchronization signal (SS) block. Here, the first group of OFDM symbols includes two OFDM symbols. The method also comprises mapping the PBCH signal to resource elements on a second group of OFDM symbols within the SS block. Here, the second group of OFDM symbols includes two or more OFDM symbols. Further, the method comprises mapping the DMRSs for the PBCH signal to the resource elements on the second group of OFDM symbols within the SS block.

### CROSS REFERENCE

This application claims the benefit of U.S. Provisional Patent Application No. 62/521,263, filed on Jun. 16, 2017, which is hereby incorporated by reference as if fully set forth herein.

### BACKGROUND OF THE INVENTION

### Field of the Invention

The present invention relates to a wireless communication system supporting NR (New RAT) technology. More specifically, the present invention related to methods and devices for communicating demodulation reference signals (DMRSs) for a PBCH (Physical Broadcast Channel) signal within a synchronization signal (SS) block.

### Discussion of the Related Art

As an example of a mobile communication system to which the present invention is applicable, a 3rd Generation Partnership Project Long Term Evolution (hereinafter, referred to as LTE) communication system is described in brief.

FIG. 1 is a block diagram illustrating network structure of an evolved universal mobile telecommunication system (E-UMTS). The E-UMTS may be also referred to as an LTE system. The communication network is widely deployed to provide a variety of communication services such as voice (VoIP) through IMS and packet data.

As illustrated in FIG. 1, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from eNodeB 20 to UE 10, and “uplink” refers to communication from the UE to an eNodeB. UE 10 refers to communication equipment carried by a user and may be also referred to as a mobile station (MS), a user terminal (UT), a subscriber station or a wireless device. eNode B 20 may be reffered to as eNB, gNB etc. However, in the following explanation, the term ‘UE’ and ‘eNodeB’ are used for convenience.

In order to connect to the network, UEs need to perform initial cell search. For this purpose Primary Synchronisation Signals (PSS) and Secondary Synchronisation Signals (SSS) are used.

FIGS. 2 and 3 are diagrams showing a method of transmitting synchronization signals in the case of using a normal CP and an extended CP.

The Synchronization Signal (SS) includes a primary SS (PSS) and a secondary SS (SSS) and is used to perform cell search. FIGS. 2 and 3 show frame structures for transmission of the SSs in systems using a normal CP and an extended CP, respectively. The SS is transmitted in second slots of subframe 0 and subframe 5 in consideration of a GSM frame length of 4.6 ms for ease of inter-RAT measurement and a boundary of the radio frame may be detected via an SSS. The PSS is transmitted in a last OFDM symbol of the slot and the SSS is transmitted in an OFDM symbol located just ahead of the PSS. The SS may transmit a total of 504 physical layer cell IDs via a combination of three PSS and 168 SSSs. In addition, the SS and the PBCH are transmitted in 6 RBs located at the center of the system bandwidth and may be detected or decoded by the UE regardless of transmission bandwidth.

In the development to a New Radio Access Technology (NR), one major new feature of 5G is multiple numerologies which can be mixed and used simultaneously. A numerology is defined by its subcarrier spacing (the width of subcarriers in the frequency domain) and by its cyclic prefix.

5G defines a base subcarrier spacing of 15 kHz. Other subcanrier spacings are defined with respect to the base subcarrier spacing. Scaling factors 2m with mϵ{−2, 0, 1, . . . , 5} define subcarrier spacings of 15 KHz*2m. Table 1 compares some subcarrier spacings.

TABLE 1

| m= | −2 (ffs) | 0 | 1 | 2 | 3 | 4 | 5 |
|---|---|---|---|---|---|---|---|
| Subcarrier spacing [kHz] | 3.75 | 15 | 30 | 60 | 120 | 240 | 480 |

The symbol and slot length will scale with the subcarrier spacing. There are either 7 or 14 symbols per slot. Cyclic prefix (CP) lengths also depend on subcarrier spacings, whereas multiple CP lengths per subcarrier spacing can still be configured.

In this situation, there are needs for more efficient way to perform cell searching.

### SUMMARY OF THE INVENTION

To achieve these objects and other advantages and in accordance with the purpose of the invention, as embodied and broadly described herein, a method for transmitting self-contained demodulation reference signals (DMRSs) for a PBCH (Physical Broadcast Channel) signal, the method comprising: mapping a primary synchronization signal (PSS) and a secondary synchronization signal (SSS) to resource elements on a first group of OFDM (Orthogonal Frequency Divisional Multiplex) symbols within a synchronization signal (SS) block, wherein the first group of OFDM symbols includes two OFDM symbols; mapping the PBCH signal to resource elements on a second group of OFDM symbols within the SS block, wherein the second group of OFDM symbols includes two or more OFDM symbols; mapping the self-contained DMRSs for the PBCH signal to the resource elements on the second group of OFDM symbols within the SS block, and transmitting the SS block to a receiving end device, is proposed.

The second group of OFDM symbols may include a first OFDM symbol and a second OFDM symbol on which neither the PSS nor SSS is mapped, and the first OFDM symbol and the second OFDM symbols may be separated from each other by at least 1 OFDM symbol.

The self-contained DMRSs may be mapped on the same subcarriers on each OFDM symbol of the first and the second OFDM symbols.

The self-contained DMRSs may be mapped on every N subcarriers per OFDM symbol per resource block (RB), N being an integer between 2 and 6.

The self-contained DMRSs may be mapped with equal spacing in a frequency domain on each OFDM symbol of the second group of OFDM symbols.

The self-contained DMRSs for the PBCH signal may be transmitted via a single antenna port.

Subcarrier indexes for the self-contained DMRSs for the PBCH signal may be differently determined based on cell ID.

The self-contained DMRSs for the PBCH may be generated by using a Gold sequence.

The SS block may be a SS/PBCH (synchronization signal/Physical Broadcast Channel) block consisting 4 OFDM symbols carrying the PSS, the SSS, and the PBCH signal multiplexed with the self-contained DMRSs.

Preferably, the self-contained DMRSs for the PBCH signal are dedicated DMRSs for the PBCH signal.

In another aspect of the present invention, a method for receiving a PBCH (Physical Broadcast Channel) signal with self-contained demodulation reference signals (DMRSs) for the PBCH signal, the method comprising: receiving a primary synchronization signal (PSS) and a secondary synchronization signal (SSS) through resource elements on a first group of OFDM (Orthogonal Frequency Divisional Multiplex) symbols within a synchronization signal (SS) block from a transmitting end device, wherein the first group of OFDM symbols includes two OFDM symbols; receiving the PBCH signal through resource elements on a second group of OFDM symbols within the SS block, wherein the second group of OFDM symbols includes two or more OFDM symbols; and receiving the self-contained DMRSs for the PBCH signal through the resource elements on the second group of OFDM symbols within the SS block, is proposed.

In another aspect of the present invention, a transmitting end device for transmitting self-contained demodulation reference signals (DMRSs) for a PBCH (Physical Broadcast Channel) signal, the device comprising: a processor configured to: map a primary synchronization signal (PSS) and a secondary synchronization signal (SSS) to resource elements on a first group of OFDM (Orthogonal Frequency Divisional Multiplex) symbols within a synchronization signal (SS) block, wherein the first group of OFDM symbols includes two OFDM symbols; map the PBCH signal to resource elements on a second group of OFDM symbols within the SS block, wherein the second group of OFDM symbols includes two or more OFDM symbols; and map the self-contained DMRSs for the PBCH signal to the resource elements on the second group of OFDM symbols within the SS block; and a transceiver connected to the processor and one or more antenna ports, and configured to transmit the SS block to a receiving end device, is proposed.

In another aspect of the present invention, a receiving end device for receiving a PBCH (Physical Broadcast Channel) signal with self-contained demodulation reference signals (DMRSs) for the PBCH signal, the device comprising: a transceiver configured to: receive a primary synchronization signal (PSS) and a secondary synchronization signal (SSS) through resource elements on a first group of OFDM (Orthogonal Frequency Divisional Multiplex) symbols within a synchronization signal (SS) block from a transmitting end device, wherein the first group of OFDM symbols includes two OFDM symbols; receive the PBCH signal through resource elements on a second group of OFDM symbols within the SS block, wherein the second group of OFDM symbols includes two or more OFDM symbols; and receive the self-contained DMRSs for the PBCH signal through the resource elements on the second group of OFDM symbols within the SS block; and a processor connected to the transceiver and configured to process the SS block, is proposed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating network structure of an evolved universal mobile telecommunication system (E-UMTS);

FIGS. 2 and 3 are diagrams showing a method of transmitting synchronization signals in the case of using a normal CP and an extended CP;

FIG. 4 shows a concept of SS block according to one example of the present invention;

FIG. 5 shows decoding performance comparison between SSS and self-contained DMRS according to one embodiment of the present invention;

FIG. 6 is a diagram to explain the DMRS patterns according to the examples of the present invention;

FIG. 7 is for explaining the density of the self-contained DMRS according to examples of the present invention;

FIG. 8 shows examples of self-contained DMRS location according to NR-PBCH symbol spacing

FIGS. 9 and 10 show CDF of estimated CFO according to different NR-PBCH symbol spacing,

FIG. 11 shows another example of the SS block according to the present invention; and

FIG. 12 is a block diagram of a communication apparatus according to an embodiment of the present invention.

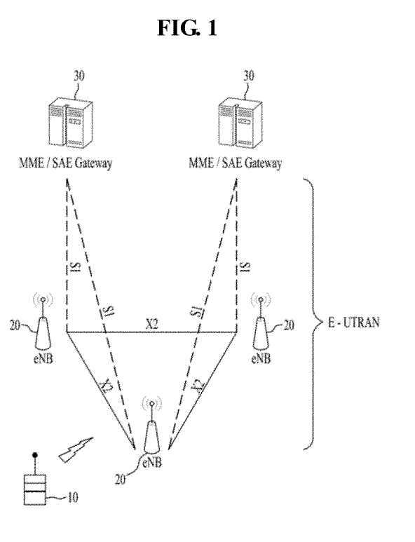

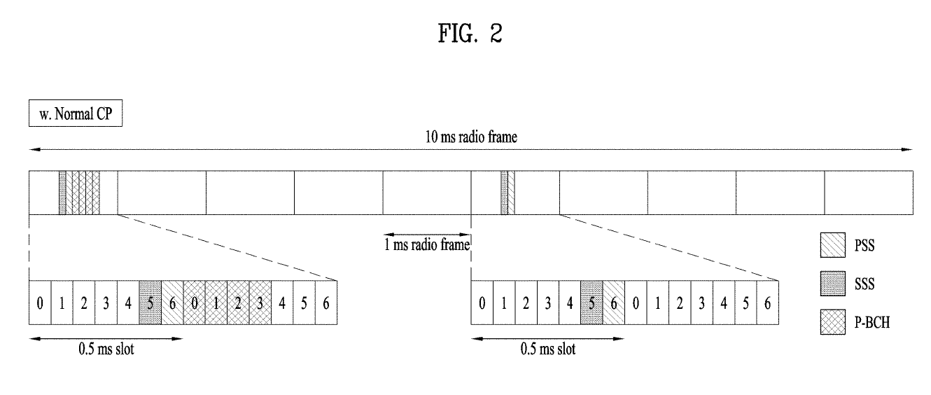

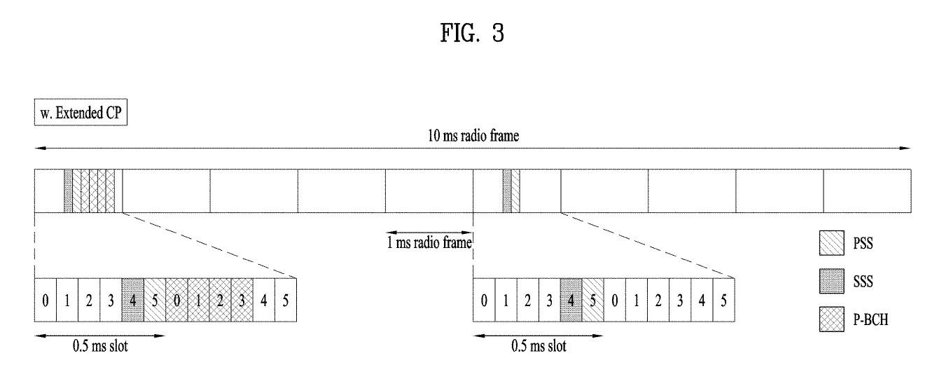

### DETAILED DESCRIPTION OF THE INVENTION

Reference will now be made in detail to the preferred embodiments of the present invention with reference to the accompanying drawings. The detailed description, which will be given below with reference to the accompanying drawings, is intended to explain exemplary embodiments of the present invention, rather than to show the only embodiments that can be implemented according to the invention.

The following detailed description includes specific details in order to provide a thorough understanding of the present invention. However, it will be apparent to those skilled in the art that the present invention may be practiced without such specific details. In some instances, known structures and devices are omitted or are shown in block diagram form, focusing on important features of the structures and devices, so as not to obscure the concept of the invention.

As described before, the following description relates to methods and devices for communicating self-contained demodulation reference signals (DMRSs) for a PBCH (Physical Broadcast Channel) signal within a synchronization signal (SS) block.

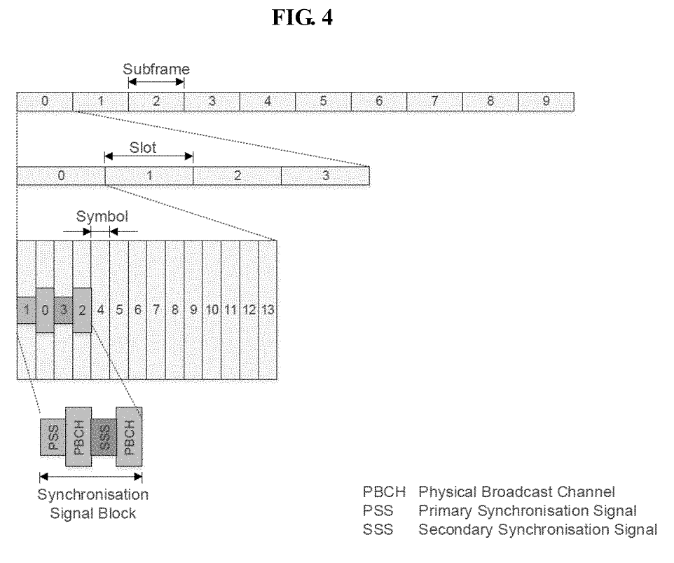

FIG. 4 shows a concept of SS block according to one example of the present invention.

In an example of FIG. 4, one frame includes 10 subframes, each having 4 slots. And, one slot may include 14 OFDM symbols. However, the time units may be differently defined in NR system from the example of FIG. 4.

In this example, a synchronization signal (SS) block can be defined as a block consisting 4 OFDM symbols carrying the PSS, the SSS, and the PBCH signal. In FIG. 4, the PSS and the SSS are mapped to resource elements on a first and a third OFDM symbols. And, the PBCH signal is to resource elements on a second and a fourth OFDM symbols. For convenience of explanation, the OFDM symbols for PSS and SSS can be defined as a first group of OFDM symbols, and the OFDM symbols for the PBCH can be defined as a second group of OFDM symbols.

PBCH is a physical channel carrying basic system information (i.e. MIB (Master Information Block). Payload size of the PBCH may be set as 80 bits (64 bits information, 16 bits CRC). Also, contents of the PBCH may include at least part of SFN/H-SFN and PDSCH configuration information (to receive remaining minimum SI).

As stated above, NR-PBCH carries a part of minimum SI and the NR-PBCH is the first channel that UE has to decode to get accessed to a network, which should be decodable at low SNR ranges. Due to the above mentioned payload size, one example of the present invention propose that NR-PBCH is transmitted rather wider bandwidth than PSS/SSS in order to occupy more REs within SS Block, as shown in FIG. 4.

Also, according to one example of the present invention, it is proposed that NR-PBCH spans at least two OFDM symbols, as shown in FIG. 4, for both PBCH decoding performance and frequency tracking using NR-PBCH DM-RS, which is explained below.

On the other hand, as for the demodulation RS for NR-PBCH, the following 3 options can be considered:

(1) Using Synchronization Signal (e.g. NR-SSS) for demodulation

(2) Using Self-contained DMRS

(3) Using MRS multiplexed in an SS block, if MRS is supported in an SS block.

NR-PSS/SSS need to be transmitted with the same transmission bandwidth in order to guarantee detection performance and coherent detection for SSS. In addition, considering NR-PSS detection complexity at UE side transmission bandwidth of PSS can be narrow, e.g 2.16 MHz. However, considering NR-PBCH design principle, NR-PBCH can be transmitted over relatively wide bandwidth to achieve frequency selective diversity gain considering UEs at lower SNR ranges. In other words, NR-SSS is not appropriate to use for NR-PBCH demodulation. Since NR-PBCH carries more information than synchronization signal does and hence NR-PBCH occupies more time/frequency resources and dedicated DM-RS ie preferable to be defined for NR-PBCH demodulation.

The term ‘self-contained DMRSs’ can be defined as DMRSs independently defined for PBCH. That is, the self-contained DMRSs are independently generated/mapped/transmitted independent from DMRSs for PDSCH, PDCCH etc. Also, the self-contained DMRSs are mapped/transmitted within the resource region through which the PBCH is transmitted.

In addition, this NR-PBCH DM-RS with wide transmission bandwidth and multiple symbols can also be performed as a tracking RS to compensate residual frequency offset. In the following explanation, we evaluated the NR-PBCH demodulation performance of NR-SSS and NR-PBCH DM-RS considering the residual CFO impact.

In section, we provide performance result according to transmission scheme and demodulation reference signal. In this evaluation, we assume that two OFDM symbols with 24 RBs (i.e. 1^{st} and 3^{rd} OFDM symbol within SS Block are used for NR-PBCH, and 2^{nd} OFDM symbol is assigned for NR-SSS) are used for NR-PBCH transmission.

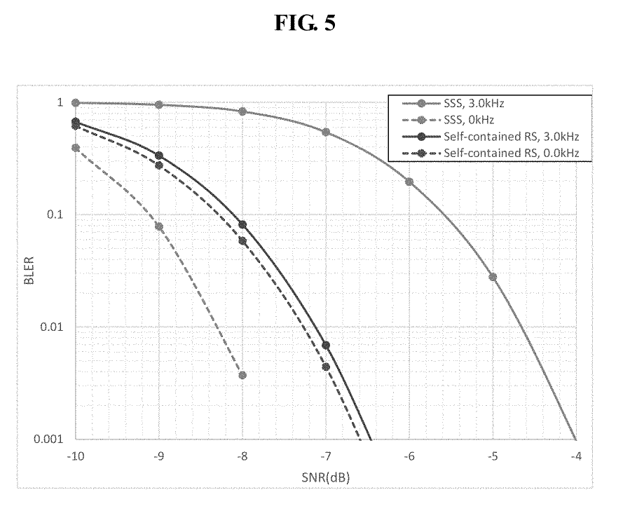

FIG. 5 shows decoding performance comparison between SSS and self-contained DMRS according to one embodiment of the present invention.

In this evaluation, it is assumed that 0˜10% of subcarrier spacing (i.e. 0 kHz˜30 kHz) is remained as frequency offset after NR-SSS detection, and NR-PBCH demodulation is operated without fine frequency offset tracking and compensation. Note that single port based transmission scheme is used for this evaluation, as will be explained below, and NR-SSS and NR-PBCH have same transmission bandwidth (i.e. 8.64 MHz).

Also, in FIG. 5, 30 kHz SCS, 120 km/h are assumed.

In case of no frequency offset, NR-SSS based NR-PBCH decoding shows better performance than self-contained DMRS because the number RE used for RS is larger and NR-PBCH coding rate is lower in NR-SSS case. On the other hand, in case that residual frequency offset is existed, NR-SSS based NR-PBCH decoding experience performance degradation due to phase shift according to frequency offset. It means that fine frequency offset tracking and compensation should be mandated in order to apply NR-SSS based NR-PBCH demodulation. In this case, NR-PBCH decoding latency could be increased due to fine frequency offset tracking operation.

Self-contained DMRS shows superior performance as observed when 3 kHz frequency offset remains, because self-contained DMRS can be located on every NR-PBCH symbol, so frequency offset is compensated by estimated channel using DMRS. Therefore, we can see that self-contained DMRS is beneficial for NR-PBCH demodulation, and additional mechanism for phase tracking is not necessity.

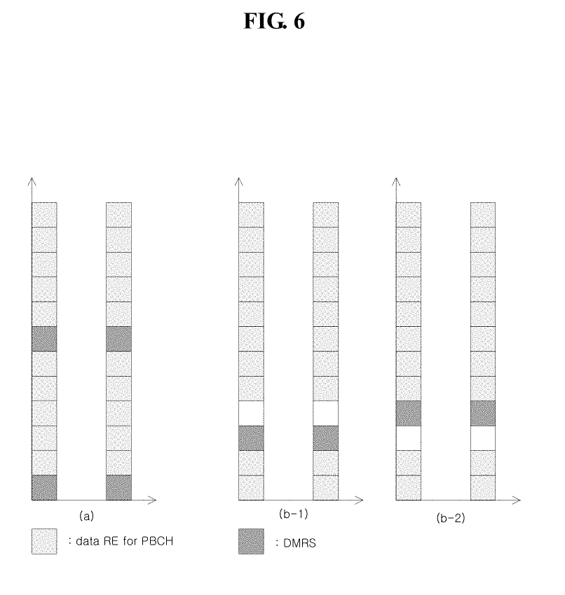

FIG. 6 is a diagram to explain the DMRS patterns according to the examples of the present invention.

FIG. 6 (a) pattern can be used for single antenna port based transmission, and FIG. 6 (b) pattern can be applied for two antenna port based SFBC. In this evaluation, we assume three kinds of RS density. In this case, DMRS position in frequency domain is changed according to RS density, which keeps equal distance between reference signals.

Also, it is assumed that NR-PBCH is transmitted at every 10 ms, and encoded bits are transmitted within 80 ms.

In the examples of FIG. 6, it is proposed that the self-contained DMRSs are positioned in the same subcarrier(s) on each OFDM symbol.

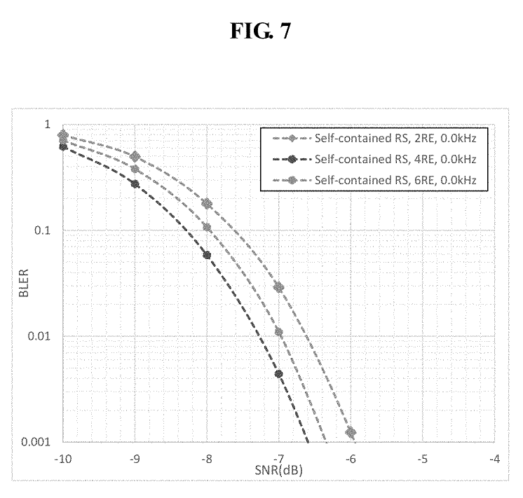

FIG. 7 is for explaining the density of the self-contained DMRS according to examples of the present invention.

At the low SNR region, channel estimation performance enhancement is an important factor for demodulation performance enhancement. However, when RS density of NR-PBCH is increased, the channel estimation performance is improved, but coding rate is decreased. So, in order to see the trade-off between channel estimation performance and channel coding gain, we compare the decoding performance according to DMRS density.

In one example of the present invention, it is proposed that the self-contained DMRSs are mapped on every N subcarriers per OFDM symbol per resource block (RB), where N being an integer between 2 and 6.

In this evaluation, we assume the following alternatives for RS density. Note that single port based transmission scheme is used for this evaluation.

(1) 2 RE per symbol per RB

(2) 4 RE per symbol per RB

(3) 6 RE per symbol per RB

As shown in FIG. 7, NR-PBCH decoding performance of (2) is better than performance of (1) because of better channel estimation performance. On the other hand, (3) shows worse performance than (2), because the effect of the coding rate loss is huger than the gain of channel estimation performance enhancement. As observed in this evaluation, 4 RE per symbol per RB seems proper point of RS density.

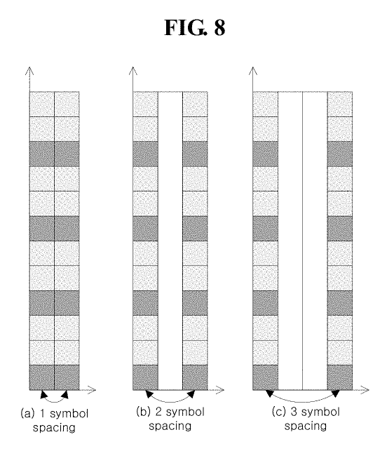

In other aspect, in the following, we provide the potential usage for CFO estimation using self-contained DMRS. If NR supports self-contained DMRS, we can expect that fine frequency offset tracking is operated using self-contained DMRS for NR-PBCH. Since frequency offset estimation accuracy depends on the OFDM symbol distance, we assume three types of NR-PBCH symbol spacing as shown in FIG. 8.

FIG. 8 shows examples of self-contained DMRS location according to NR-PBCH symbol spacing.

This simulation is performed on SNR −6 dB, and 10% CFO (1.5 kHz) is applied over samples in a subframe. 4 REs per symbol per RB per port are used as self-contained RS, and located on the symbols where PBCH is transmitted. Following results show the performance of CFO estimation using self-contained DMRS for NR-PBCH.

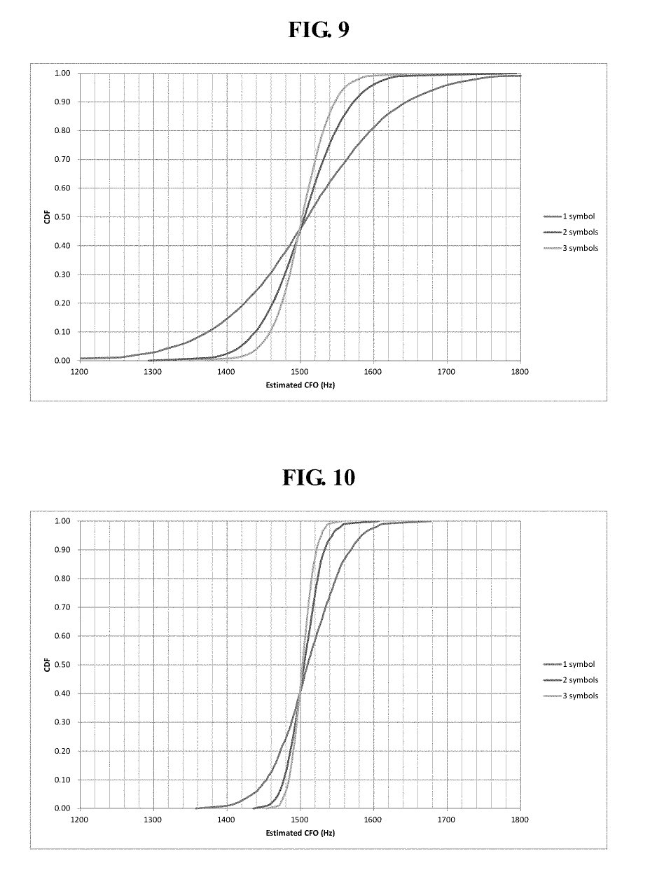

FIGS. 9 and 10 show CDF of estimated CFO according to different NR-PBCH symbol spacing.

Specifically, FIG. 9 is for 10 subframe average, and FIG. 10 is for 50 subframe average.

As seen in the FIGS. 9 and 10, CFO of 1.5 kHz is well estimated within error of ±200 Hz by 90% of UEs in both cases, and if at least 2 symbol is introduced as NR-PBCH symbol spacing, 95% of UEs shows error within ±200 Hz, and 90% of UEs shows error within ±100 Hz in both cases. CFO estimation performance is better when the spacing between PBCH symbols is larger, because phase offset caused by the CFO grows large as spacing increase, making easy to measure phase offset with similar effect as noise suppression. Also, large average window helps the accuracy of CFO estimation.

Transmission Scheme and Antenna Ports

Since NR-PBCH is the first channel to decode, it is not expected any signalling assistance on NR-PBCH transmission scheme or antenna ports for UEs in idle mode. Since it is decided that no blind detection on the NR-PBCH detection or number of antenna ports at UE side are allowed, the following 2 alternatives can be considered.

Alt. 1: Two antenna port based SFBC

Alt. 2: A single antenna port based transmission scheme

Considering DM-RS overhead and the PBCH decoding performance at lower SNR ranges, single antenna port based transmission scheme is preferred in one example of the present invention. The above evaluations are based on the single port based transmission scheme, as stated above.

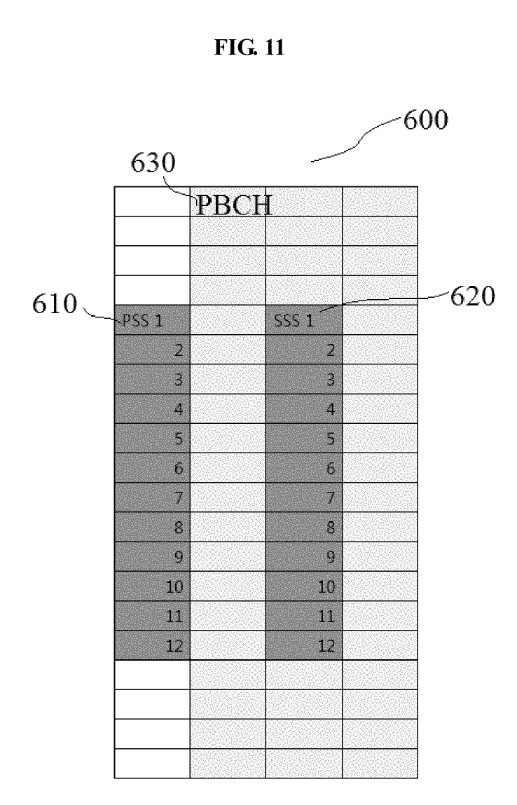

FIG. 11 shows another example of the SS block according to the present invention.

In FIG. 11, the horizontal axis represents the time domain and vertical axis represents the frequency domain. One block in the grid of FIG. 11 can be represented by 1 OFDM symbol and 1 subcarrier.

In this example, PSS is mapped to the first OFDM symbol and SSS is mapped to the third OFDM symbol, as in the example of FIG. 4. However, the PBCH together with the self-contained DMRS for the PBCH are mapped to 2^{nd} to 4^{th} a OFDM symbols. Here, the PBCH on the 3^{rd} OFDM symbol may take the rest of the REs not used for PSS/SSS. That is, in order to support the big payload size of the PBCH, the SS block may use the rest of the subcarriers on (part of) the first group of OFDM symbols (1^{st} and 3^{rd} OFDM symbol).

As explained above, the demodulation performance of DMRS can be increased when the two OFDM symbols are separated from each other by at least 1 OFDM symbol. In FIG. 11, 2^{nd} and 4^{th} OFDM symbols are the ones where neither the PSS nor SSS is mapped. They are separated from each other by 1 OFDM symbol, as shown in FIG. 11.

NR-PBCH DMRS Pattern Design

For the DMRS design, it is efficient to examine DMRS overhead, time/frequency position and scrambling sequence. Overall PBCH decoding performance can be decided by channel estimation performance and NR-PBCH coding rate. Since the number of RE for DMRS transmission has a trade-off between channel estimation performance and PBCH coding rate, we need to find the appropriate number of RE for DMRS. In this contribution, we provided evaluation result of PBCH decoding performance according the number of DMRS. In this evaluation, we can see that when 4 REs per RB (⅓ density) is assigned for DMRS, better performance is provided. When two OFDM symbols are assigned for NR-PBCH transmission, 192 REs for DMRS and 384 REs for MIB transmission are used. In this case, when 64 bits of payload size is assumed, 1/12 coding rate can be achieved, which is same coding rate with LTE PBCH.

According to one example of the present invention, it is proposed that DMRS is introduced for phase reference of NR-PBCH. In this example, RE mapping scheme for DMRS will be examined.

Two mapping schemes can be presented. Equal mapping scheme uses each PBCH symbol, and DMRS sequence is mapped on subcarriers with equal interval. Unequal mapping scheme use each PBCH symbol, and DMRS sequence is not mapped within NR-SSS transmission bandwidth. Instead, unequal mapping scheme use NR-SSS for PBCH demodulation. Therefore, unequal mapping scheme could have more resource for channel estimation than equal mapping method and could use more RE for data transmission. However, in the initial access process, residual CFO can be exist, so channel estimation using SSS symbol could not be accurate. Also, equal mapping scheme has an advantage in CFO estimation and fine time tracking. If SS block time indication is presented in PBCH DMRS, equal mapping scheme can have additional benefit.

In this example, it is proposed to use the equal mapping scheme since the performance of equal mapping scheme is better than that of unequal mapping scheme. For initial access process, equal mapping scheme seems to be more appropriate.

Also, regarding on frequency position of DMRS, we can assume the interleaved mapping in frequency domain, which can be shifted according to cell-ID. Equally distributed DMRS pattern could have benefit to use DFT based channel estimation which provides optimal performance in case of 1-D channel estimation.

The above explained SS block can be differently called as SS/PBCH block. In the time domain, an SS/PBCH block may consist of 4 OFDM symbols, numbered in increasing order from 0 to 3 within the SS/PBCH block, where PSS, SSS, and PBCH with associated DM-RS occupy different symbols as given by following Table 2.

TABLE 2

| | OFDM symbol | Subcarrier |
|---|---|---|
| | number l relative | number k relative |
| Channel | to the start of | to the start of |
| or signal | an SS/PBCH block | an SS/PBCH block |
| PSS | 0 | 56, 57, . . . , 182 |
| SSS | 2 | 56, 57, . . . , 182 |
| Set to 0 | 0 | 0, 1, . . . , 55, 183, 184, . . . , 236 |
| | 2 | 48, 49, . . . , 55, 183, 184, . . . , 191 |
| PBCH | 1, 3 | 0, 1, . . . , 239 |
| | 2 | 0, 1, . . . , 47, 192, 193, . . . , 239 |
| DM-RS for | 1, 3 | 0 + v, 4 + v, 8 + v, . . . , 236 + v |
| PBCH | 2 | 0 + v, 4 + v, 8 + v, . . . , 44 + v |
| | | 192 + v, 196 + v, . . . , 236 + v |

In the frequency domain, an SS/PBCH block consists of 240 contiguous subcarriers with the subcarriers numbered in increasing order from 0 to 239 within the SS/PBCH block. The quantities k and 1 represent the frequency and time indices, respectively, within one SS/PBCH block. The UE may assume resource elements denoted as ‘Set to 0’ in Table 2 are set to zero. Subcarrier 0 in an SS/PBCH block corresponds to subcarrier k₀ in common resource block N_{CRB}^{SSB}, where N is obtained from the higher-layer parameter offset-ref-low-scs-ref-PRB.

For an SS/PBCH block, the UE shall assume
antenna port p=4000,
the same cyclic prefix length and subcarrier spacing for the PSS, SSS, and PBCH,
for SS/PBCH block type A, k₀ϵ{0, 1, 2, . . . , 23}, μϵ{0, 1}, and N_{CRB}^{SSB} is expressed in terms of 15 kHz subcarrier spacing, and
for SS/PBCH block type B, k₀ₐ ϵ{0, 1, 2, . . . , 11}, μϵ{3,4}, and N_{CRB}^{SSB} is expressed in terms of 60 kHz subcarrier spacing.

The UE may assume that SS/PBCH blocks transmitted with the same block index are quasi co-located with respect to Doppler spread, Doppler shift, average gain, average delay, and spatial Rx parameters. The UE shall not assume quasi co-location for any other SS/PBCH block transmissions.

The self-contained DMRS of one example can be generated by using a Gold sequence.

The UE shall assume the reference-signal sequence r(m) for an SS/PBCH block is defined by:

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) \qquad [ Equation 1 ]$$

where c(n) is given by using the Gold sequence. The scrambling sequence generator shall be initialized at the start of each SS/PBCH block occasion with:

cᵢₙᵢₜ=2¹¹+(ī_{SSB}+1)(└N_{ID}^{cell}/4┘+1)+2⁶/(ī_{SSB}+1)+(N_{ID}^{cell} mod 4)

ī_{SSB}=4i_{SSB}+n_{hf} [Equation 2]

Where
for Lₘₐₓ=4, n_{hf} is the number of the half-frame in which the PBCH is transmitted in frame and i_{SSB} is the two least significant bits of the SS/PBCH index.
for Lₘₐₓ=8 or Lₘₐₓ=64, n_{hf}=0 and i_{SSB} is the three least significant bits of the SS/PBCH index

with Lₘₐₓ being the maximum number of SS/PBCH beams in an SS/PBCH period for a particular band.

Apparatus for SS Block Communication

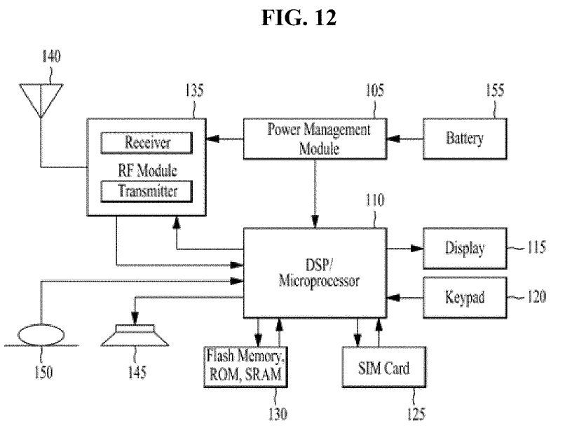

FIG. 12 is a block diagram of a communication apparatus according to an embodiment of the present invention.

The apparatus shown in FIG. 12 can be a user equipment (UE) and/or eNB adapted to perform the above mechanism, but it can be any apparatus for performing the same operation.

As shown in FIG. 12, the apparatus may comprises a DSP/microprocessor (110) and RF module (transceiver: 135). The DSP/microprocessor (110) is electrically connected with the transceiver (135) and controls it. The apparatus may further include power management module (105), battery (155), display (115), keypad (120), SIM card (125), memory device (130), speaker (145) and input device (150), based on its implementation and designer's choice.

Specifically, FIG. 12 may represent a UE comprising a receiver (135) configured to receive signal from the network, and a transmitter (135) configured to transmit signals to the network. These receiver and the transmitter can constitute the transceiver (135). The UE further comprises a processor (110) connected to the transceiver (135: receiver and transmitter).

Also, FIG. 12 may represent a network apparatus comprising a transmitter (135) configured to transmit signals to a UE and a receiver (135) configured to receive signal from the UE. These transmitter and receiver may constitute the transceiver (135). The network further comprises a processor (110) connected to the transmitter and the receiver.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

The embodiments of the present invention described herein below are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by subsequent amendment after the application is filed.

In the embodiments of the present invention, a specific operation described as performed by the BS may be performed by an upper node of the BS. Namely, it is apparent that, in a network comprised of a plurality of network nodes including a BS, various operations performed for communication with an MS may be performed by the BS, or network nodes other than the BS. The term ‘eNB’ may be replaced with the term ‘fixed station’, ‘Node B’, ‘Base Station (BS)’, ‘access point’, ‘gNB’, etc.

The above-described embodiments may be implemented by various means, for example, by hardware, firmware, software, or a combination thereof.

In a hardware configuration, the method according to the embodiments of the present invention may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, or microprocessors.

In a firmware or software configuration, the method according to the embodiments of the present invention may be implemented in the form of modules, procedures, functions. etc. performing the above-described functions or operations. Software code may be stored in a memory unit and executed by a processor. The memory unit may be located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

While the above-described method has been described centering on an example applied to the 3GPP system, the present invention is applicable to a variety of wireless communication systems, e.g. IEEE system, in addition to the 3GPP system.

What is claimed is:

1. A method for transmitting demodulation reference signals (DMRSs) for a PBCH (Physical Broadcast Channel) signal, the method comprising:
mapping a primary synchronization signal (PSS) and a secondary synchronization signal (SSS) to resource elements on a first group of OFDM (Orthogonal Frequency Divisional Multiplex) symbols within a synchronization signal (SS) block, wherein the first group of OFDM symbols includes two OFDM symbols;
mapping the PBCH signal to resource elements on a second group of OFDM symbols within the SS block, wherein the second group of OFDM symbols includes two or more OFDM symbols;
mapping the DMRSs for the PBCH signal to the resource elements on the second group of OFDM symbols within the SS block; and
transmitting the SS block to a receiving end device.

2. The method of claim 1, wherein the second group of OFDM symbols include a first OFDM symbol and a second OFDM symbol on which neither the PSS nor SSS is mapped, and
wherein the first OFDM symbol and the second OFDM symbols are separated from each other by at least 1 OFDM symbol.

3. The method of claim 2, wherein the DMRSs are mapped on the same subcarriers on each OFDM symbol of the first and the second OFDM symbols.

4. The method of claim 1, wherein the DMRSs are mapped on every N subcarriers per OFDM symbol per resource block (RB), N being an integer between 2 and 6.

5. The method of claim 1, wherein the DMRSs are mapped with equal spacing in a frequency domain on each OFDM symbol of the second group of OFDM symbols.

6. The method of claim 1, wherein the DMRSs for the PBCH signal are transmitted via a single antenna port.

7. The method of claim 1, wherein subcarrier indexes for the DMRSs for the PBCH signal are differently determined based on cell ID.

8. The method of claim 1, wherein the DMRSs for the PBCH are generated by using a Gold sequence.

9. The method of claim 1, wherein the SS block is a SS/PBCH (synchronization signal/Physical Broadcast Channel) block consisting 4 OFDM symbols carrying the PSS, the SSS, and the PBCH signal multiplexed with the DMRSs.

10. The method of claim 1, wherein the DMRSs for the PBCH signal are independently defined DMRSs for the PBCH signal.

11. A method for receiving a PBCH (Physical Broadcast Channel) signal with demodulation reference signals (DMRSs) for the PBCH signal, the method comprising:
receiving a primary synchronization signal (PSS) and a secondary synchronization signal (SSS) through resource elements on a first group of OFDM (Orthogonal Frequency Divisional Multiplex) symbols within a synchronization signal (SS) block from a transmitting end device, wherein the first group of OFDM symbols includes two OFDM symbols;
receiving the PBCH signal through resource elements on a second group of OFDM symbols within the SS block, wherein the second group of OFDM symbols includes two or more OFDM symbols; and
receiving the DMRSs for the PBCH signal through the resource elements on the second group of OFDM symbols within the SS block.

12. The method of claim 11, wherein the second group of OFDM symbols include a first OFDM symbol and a second OFDM symbol on which neither the PSS nor SSS is mapped, and
wherein the first OFDM symbol and the second OFDM symbols are separated from each other by at least 1 OFDM symbol.

13. The method of claim 12, wherein the DMRSs are received on the same subcarriers on each OFDM symbol of the first and the second OFDM symbols.

14. The method of claim 11, wherein the DMRSs are received on every N subcarriers per OFDM symbol per resource block (RB), N being an integer between 2 and 6.

15. The method of claim 11, wherein subcarrier indexes for the DMRSs for the PBCH signal are differently determined based on cell ID.

16. The method of claim 11, wherein the DMRSs for the PBCH are generated by using a Gold sequence.

17. A transmitting end device for transmitting demodulation reference signals (DMRSs) for a PBCH (Physical Broadcast Channel) signal, the device comprising:
a processor configured to:
map a primary synchronization signal (PSS) and a secondary synchronization signal (SSS) to resource elements on a first group of OFDM (Orthogonal Frequency Divisional Multiplex) symbols within a synchronization signal (SS) block, wherein the first group of OFDM symbols includes two OFDM symbols;
map the PBCH signal to resource elements on a second group of OFDM symbols within the SS block, wherein the second group of OFDM symbols includes two or more OFDM symbols; and
map the DMRSs for the PBCH signal to the resource elements on the second group of OFDM symbols within the SS block; and
a transceiver connected to the processor and one or more antenna ports, and configured to transmit the SS block to a receiving end device.

18. The device of claim 17, wherein the DMRSs for the PBCH signal are transmitted via a single antenna port among the antenna ports.

19. A receiving end device for receiving a PBCH (Physical Broadcast Channel) signal with demodulation reference signals (DMRSs) for the PBCH signal, the device comprising:
a transceiver configured to:
receive a primary synchronization signal (PSS) and a secondary synchronization signal (SSS) through resource elements on a first group of OFDM (Orthogonal Frequency Divisional Multiplex) symbols within a synchronization signal (SS) block from a transmitting end device, wherein the first group of OFDM symbols includes two OFDM symbols;
receive the PBCH signal through resource elements on a second group of OFDM symbols within the SS block, wherein the second group of OFDM symbols includes two or more OFDM symbols; and
receive the DMRSs for the PBCH signal through the resource elements on the second group of OFDM symbols within the SS block; and
a processor connected to the transceiver and configured to process the SS block.
